(19) United States
(12) Patent Application Publication
(10) Pub. No.: US 2018/0181037 A1
(43) Pub. Date: Jun. 28, 2018

(54) FIXING APPARATUS

(71) Applicant: CANON KABUSHIKI KAISHA, Tokyo (JP)

(72) Inventors: Hiroshi Kataoka, Suntou-gun (JP); Teruhiko Namiki, Mishima-shi (JP); Yusuke Nakashima, Yokohama-shi (JP)

(21) Appl. No.: 15/847,544

(22) Filed: Dec. 19, 2017

(30) Foreign Application Priority Data
Dec. 26, 2016 (JP) 2016-250829

(51) Int. Cl. G03G 15/20

(52) U.S. Cl. CPC G03G 15/2053

(57) ABSTRACT

A fixing apparatus includes a tubular film, a heater including a first surface and a second surface opposite to the first surface, the first surface being to contact an inner surface of the film, a supporting member including a supporting surface for supporting the heater from a side of the second surface, and a heat conductive member arranged between the second surface of the heater and the supporting surface of the supporting member, wherein a toner image is fixed on a recording material with heat of the heater via the film, and wherein the heat conductive member is attached to at least one of the second surface of the heater and the supporting surface of the supporting member via an adhesive member including silicone-based pressure-sensitive adhesive or silicone-based adhesive.

### BACKGROUND OF THE INVENTION

### Field of the Invention

The present disclosure relates to a fixing apparatus to be installed in an image forming apparatus such as an electrophotographic copying machine and an electrophotographic printer.

### Description of the Related Art

An apparatus employing a film heating method has been known as a fixing apparatus to be installed in an electrophotographic copying machine or an electrophotographic printer. Such a type of the fixing apparatus includes a tubular film, a heater for heating the film while contacting an inner peripheral surface of the film, and a pressing roller that forms a nip portion with the heater via the film. A recording material bearing an unfixed toner image is heated while being pinched and conveyed by the nip portion, so that the toner image is fixed on the recording material.

In a case where the copier or the printer performs continuous printing on small size recording materials at the same printing intervals as continuous printing performed on large size recording materials, temperature of a non-passing area of a heater in the fixing apparatus excessively rises. The non-passing area of the heater is an area through which a small size recording material does not pass. The excessive temperature rise of the non-passing area of the heater damages the film to be heated by the heater or a holder supporting the heater. Moreover, in a case where printing is performed on a large size recording material in a state in which temperature of the non-passing area of the heater has excessively risen, a hot offset can occur. In the hot offset, unfixed toner on the large size recording material can be transferred to a film surface due to melting of the unfixed toner caused by excessive heating.

Each of Japanese Patent Application Laid-Open No. 2003-317898 and Japanese Patent Application Laid-Open No. 2014-102429 discusses a configuration in which a graphite sheet is provided as a heat conductive member in a heater to suppress an excessive temperature rise of a non-passing area of the heater. The graphite is constructed of a graphite layer structure in which a plurality of thin crystal layers each including a carbon hexagonal system is overlapped as illustrated in FIG. 12. In the crystal layer, although carbons are bonded to each other by a strong covalent bond, the bonds between the overlapped crystal layers (interlayer) are week bonds by Van der Waals forces.

The graphite sheet to be used for suppression of an excessive temperature rise of a non-passing area (a non-passing portion temperature rise) of the heater is brittle since it is constructed of the graphite layer structure in which crystal layers are overlapped. Such a graphite sheet is a thin sheet member having a thickness of approximately tens to hundreds of μm and thus has low mechanical strength. Thus, the graphite sheet may tear when handled. Accordingly, the graphite sheet can be fixed to a heater or a holder to facilitate the handling thereof.

The graphite sheet, the heater, and the holder are mainly made of respective materials of carbon, ceramic, and heat-resistant resin. Hence, the graphite sheet, the heater, and the holder have different thermal expansion coefficients. Moreover, the heater and the holder thermally expand if a surface temperature of the film rises to a toner image fixable temperature. Meanwhile, the graphite sheet barely expands with heat.

Accordingly, if the materials having different thermal expansion coefficients are used in the vicinity of the heater with temperature that becomes highest inside the fixing apparatus, a shearing force acts on the graphite sheet which does not thermally expand from the heater and the holder which thermally expand. In the graphite sheet, the shearing force causes displacement between the crystal layers bonded by the weak Van der Waals force. Consequently, the graphite sheet may eventually tear. In a case where the graphite sheet tears, the non-passing portion temperature rise of the heater cannot be prevented.

### SUMMARY OF THE INVENTION

The present disclosure is directed to an image heating apparatus capable of reducing a shearing force that acts on a heat conductive member and suppressing an excess temperature rise of a heating member.

According to an aspect of the present disclosure, a fixing apparatus includes a tubular film, a heater including a first surface and a second surface opposite to the first surface, the first surface being to contact an inner surface of the film, a supporting member including a supporting surface for supporting the heater from a side of the second surface, and a heat conductive member arranged between the second surface of the heater and the supporting surface of the supporting member, wherein a toner image is fixed on a recording material with heat of the heater via the film, and wherein the heat conductive member is attached to at least one of the second surface of the heater and the supporting surface of the supporting member via an adhesive member including silicone-based pressure-sensitive adhesive or silicone-based adhesive.

Further features of the present disclosure will become apparent from the following description of exemplary embodiments with reference to the attached drawings.

### BRIEF DESCRIPTION OF THE DRAWINGS

FIG. 1 is a schematic sectional view illustrating a configuration of a fixing apparatus.

FIG. 2 is a sectional view illustrating a layer configuration of a film.

FIG. 3 is a perspective view illustrating one end portion of a pressing roller.

FIG. 4 is a schematic perspective view illustrating a supporting structure of the pressing roller.

FIGS. 5A and 5B are schematic diagrams illustrating a configuration of a heater.

FIG. 6 is a perspective view illustrating a positional relation of the film, a holder, a stay, and a flange.

FIGS. 7A and 7B are schematic diagrams illustrating a configuration of a pressure mechanism of the flange.

FIG. 8 is a perspective view illustrating a positional relation of the heater, the holder, the stay, a thermistor, and a thermostat.

FIGS. 9A and 9B are diagrams illustrating effect verification-1.

FIGS. 10A, 10B, and 10C are diagrams illustrating effect verification-2.

FIG. 11 is a schematic sectional view illustrating a configuration of an image forming apparatus.

FIG. 12 is a diagram illustrating a layer structure of a graphite sheet.

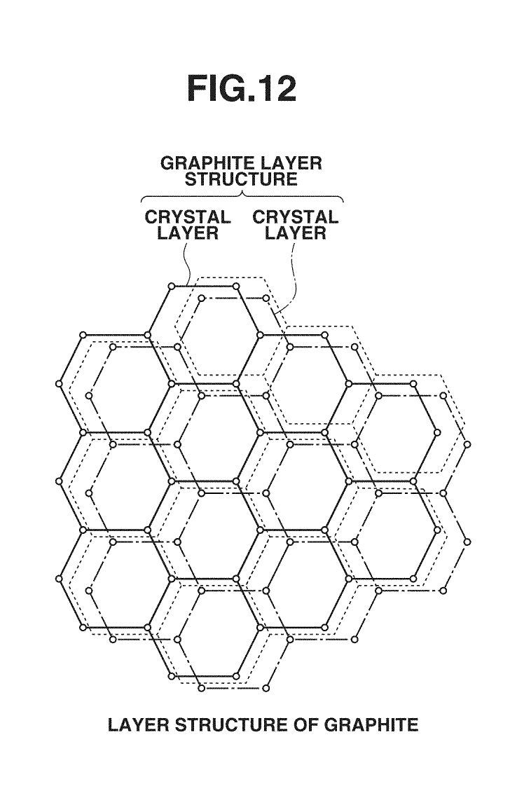

### DESCRIPTION OF THE EMBODIMENTS

Hereinafter, exemplary embodiments are described with reference to the drawings. The exemplary embodiments are merely examples, and the present disclosure is not intended to be limited to the following exemplary embodiments. The exemplary embodiments can be replaced with other various configurations within the scope of the present disclosure.

### <Image Forming Apparatus>

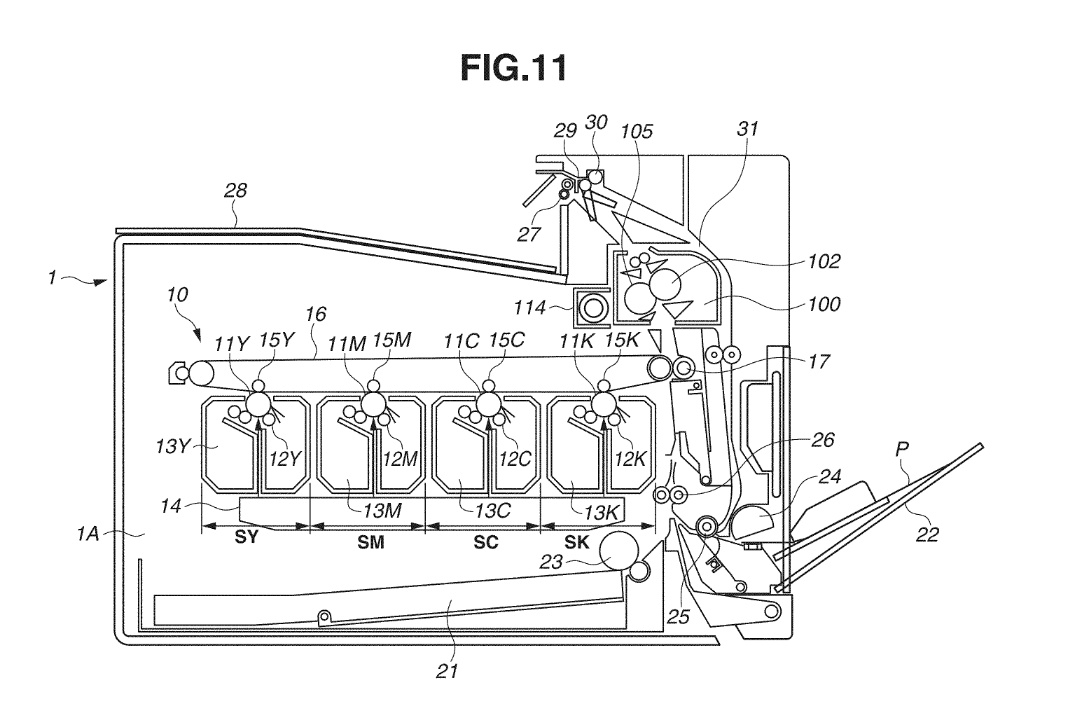

Hereinafter, a description is given of a first exemplary embodiment. An image forming apparatus 1 according to the present exemplary embodiment is described with reference to FIG. 11. FIG. 11 is a schematic sectional view illustrating one example of a configuration of the image forming apparatus 1 (a full color printer in the present exemplary embodiment) using an electrophotographic recording technique.

The image forming apparatus 1 includes an image forming unit 10 for forming an image on a recording material P using toner. The image forming unit 10 includes four image forming stations SY, SM, SC, and SK for respective colors of yellow, magenta, cyan, and black. The image forming stations SY, SM, SC, and SK respectively include photosensitive drums 11Y, 11M, 11C, and 11K as image bearing members, charging members 12Y, 12M, 12C, and 12K, developing units 13Y, 13M, 13C, and 13K, and a laser scanner 14. Moreover, the image forming unit 10 includes transfer members 15Y, 15M, 15C, and 15K, a belt 16, and a secondary transfer member 17. The belt 16 conveys toner images respectively transferred from the photosensitive drums 11Y, 11M, 11C, and 11K by the transfer members 15Y, 15M, 15C, and 15K while bearing the toner images. The secondary transfer member 17 transfers the toner images from the belt 16 to a recording material P. Since operations of the image forming unit 10 are known, detailed descriptions thereof are omitted.

Recording materials (not illustrated) stored in a cassette 21 inside an apparatus main body 1A are supplied one by one to a roller 26 by rotation of a roller 23. Alternatively, recording materials P set on a manual feed tray 22 disposed to the apparatus main body 1A can be supplied one by one to the roller 26 via a roller 25 by rotation of a roller 24. Then, rotation of the roller 26 conveys the recording material P to a secondary transfer portion formed by the belt 16 and the secondary transfer member 17. In the secondary transfer portion, a toner image is transferred to the recording material P. The recording material P bearing the unfixed toner image is conveyed to a fixing apparatus (an image heating apparatus) 100 serving as a fixing unit, and the toner image is fixed on the recording material P with heat by the fixing apparatus 100.

The recording material P having exited from the fixing apparatus 100 passes through a flapper 29, and then is discharged to a tray 28 by rotation of a roller 27.

Such print operations are performed if a single-sided printing is performed.

If a two-sided printing is performed, the recording material P is fed back to a conveyance path 31 by the flapper 29 by rotation of a roller 27, so that the recording material P is conveyed in reverse by rotation of the rollers 25 and 26. After passing through the secondary transfer portion, the fixing apparatus 100, and the flapper 29, the recording material P is discharged to the tray 28 by rotation of the roller 27.

### <Fixing Apparatus 100>

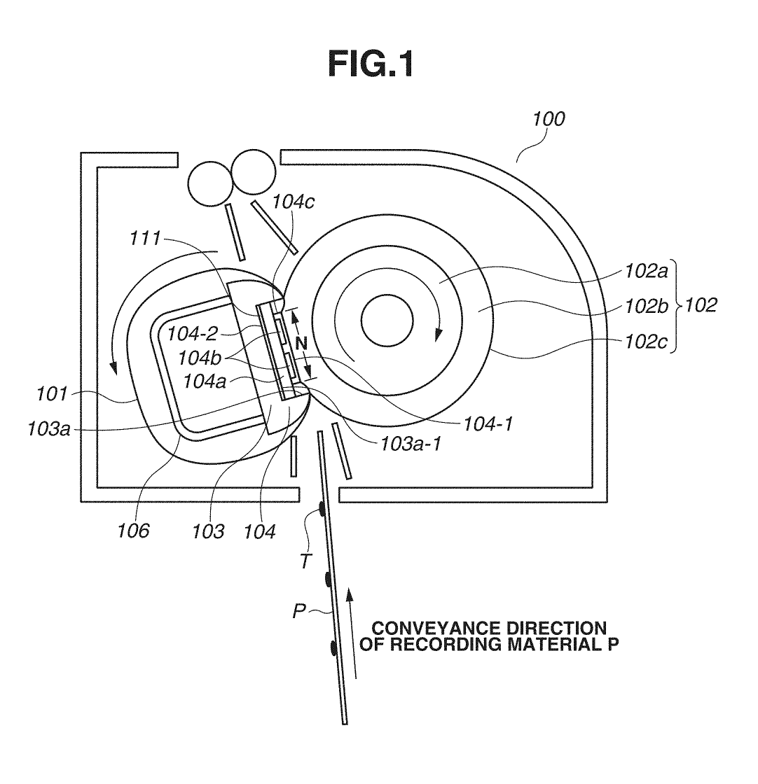

Next, the fixing apparatus 100 is described with reference to FIG. 1. FIG. 1 is a schematic sectional view illustrating a configuration of the fixing apparatus 100.

### <Overall Configuration of Fixing Apparatus 100>

The fixing apparatus 100 includes a cylindrical film 101 as a tubular rotator, a ceramic heater 104 as a heater, and a holder 103 as a supporting member. The ceramic heater (hereinafter, heater) 104 heats the film 101 while contacting an inner peripheral surface (an inner surface) of the film 101. The holder 103 supports the heater 104. Moreover, the fixing apparatus 100 includes a pressing roller 102 as a pressing rotator, and a graphite sheet 111 as a heat conductive member. The pressing roller 102 forms a nip portion N with the heater 104 via the film 101. The graphite sheet 111 is arranged between the holder 103 and the heater 104. The heater 104 includes a first surface 104-1, and a second surface 104-2 on the opposite side of the first surface. The first surface of the heater 104 is in contact with the inner surface of the film 101.

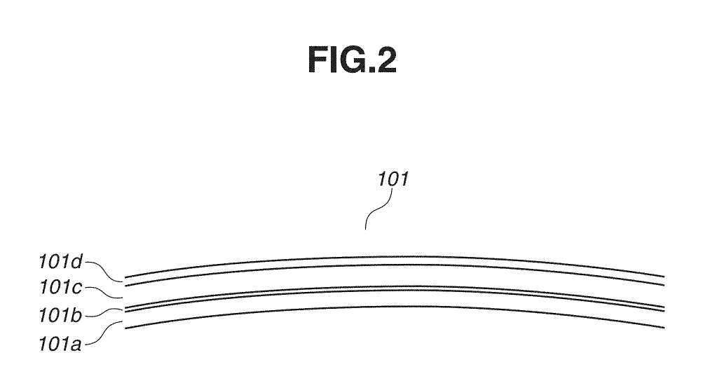

FIG. 2 is sectional view illustrating a layer configuration of the film 101.

The film 101 includes an endless base layer 101a, a primer layer 101b arranged on an outer peripheral surface of the base layer 101a, an elastic layer 101c arranged on an outer peripheral surface of the primer layer 101b, and a release layer 101d arranged on an outer peripheral surface of the elastic layer 101c.

The base layer 101a is made of heat-resistant resin such as polyimide, or metal such as stainless steel.

The primer layer 101b is formed by primer applied as an adhesive on the outer peripheral surface of the base layer 101a. The primer applied on the base layer 101a has a thickness of approximately 5 μm.

The elastic layer 101c is made of heat-resistant rubber such as silicone. With elasticity of the elastic layer 101c, an unfixed toner image T borne by the recording material P is wrapped, so that a fixing operation on the recording material P is uniformly performed with pressure.

The release layer 101d is arranged on an outermost layer of the film 101 to prevent adhesion of toner or paper powder of a recording sheet (recording material P), and to obtain separability of the recording material P from the film 101. The release layer 101d is formed by perfluoroalkoxy (PFA) resin, i.e., fluorine resin having good releasability and high heat resistance, applied on an outer peripheral surface of the elastic layer 101c. The PFA resin applied on the elastic layer 101c has a thickness of approximately 20 μm. Alternatively, the release layer 101d can be formed by covering the outer peripheral surface of the elastic layer 101c with a tube.

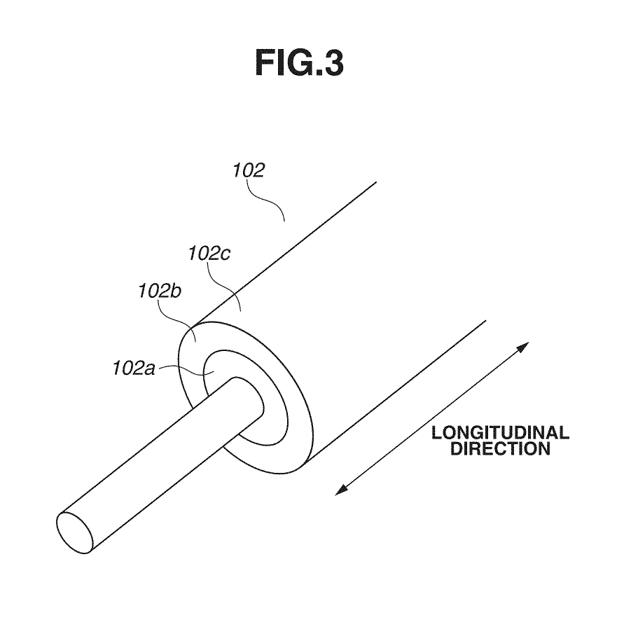

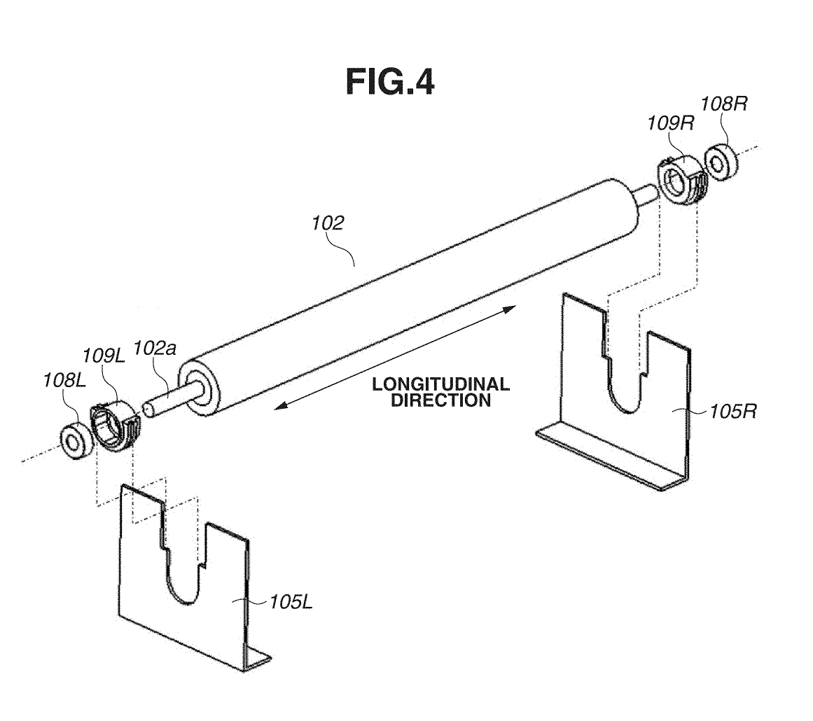

FIG. 3 is a perspective view illustrating one end portion of the pressing roller 102. FIG. 4 is a schematic perspective view illustrating a supporting structure of the pressing roller 102.

As illustrated in FIGS. 1 and 3, the pressing roller 102 includes a metal core 102a, an elastic layer 102b formed on the metal core 102a, and a release layer 102c. The metal core 102a is made of metal such as aluminum and iron. The elastic layer 102b is formed of, for example, silicone rubber. The release layer 102c covers an outer peripheral surface of the elastic layer 102b. As for the elastic layer 102b, for example, a solid rubber layer or a sponge rubber layer is used. The solid rubber layer is formed of silicone rubber, whereas the sponge rubber layer is formed by foaming silicone rubber to have a heat insulation effect. The release layer 102c is provided by covering the outer peripheral surface of the elastic layer 102b with a tube made of fluorine resin such as PFA resin.

As illustrated in FIG. 4, in a longitudinal direction perpendicular to a conveyance direction of the recording material P, bearings 108L and 108R are attached to respective end portions of the metal core 102a of the pressing roller 102. The bearings 108L and 108R are rotatably fit into respective bearing holders 109L and 109R. The bearing holders 109L and 109R are fixed in a supported manner by a pair of respective side plates 105L and 105R of the fixing apparatus 100. Hence, the pressing roller 102 is rotatably supported by the pair of side plates 105L and 105R via the bearings 108L and 108R and the bearing holders 109L and 109R.

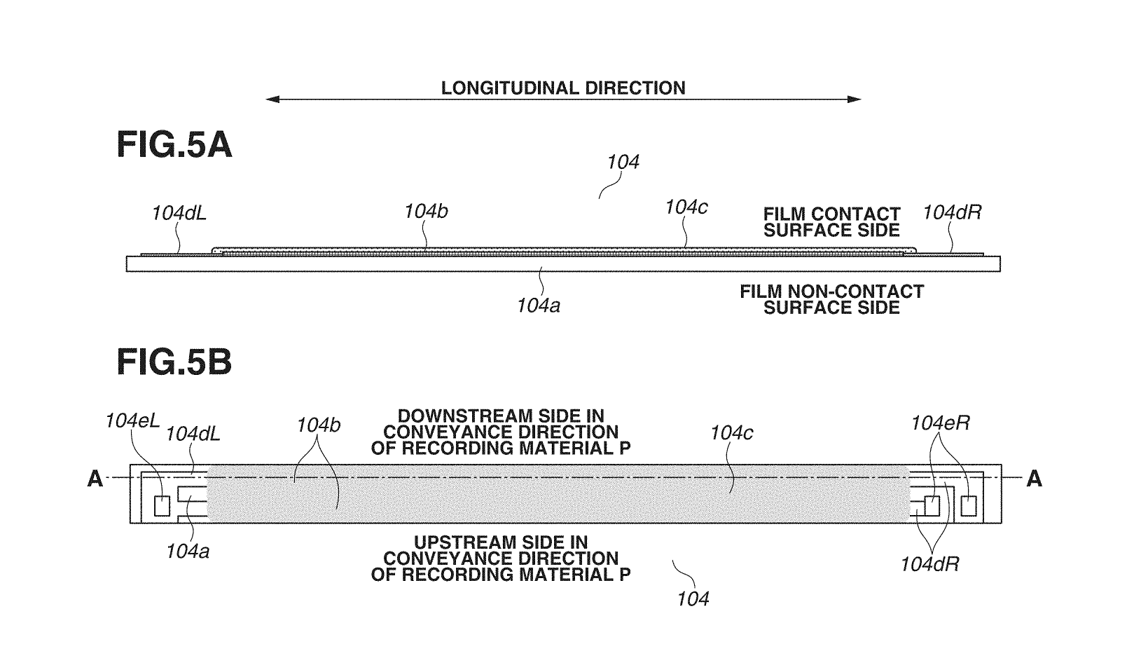

FIGS. 5A and 5B are schematic diagrams illustrating a configuration of the heater 104. FIG. 5A is a sectional view of the heater 104 along the line A-A of FIG. 5B, and FIG. 5B is a plan view of the heater 104 as seen from the contact surface side of the heater 104 with the film 101 (a film contact surface side).

As illustrated in FIG. 5, in the longitudinal direction perpendicular to the conveyance direction of the recording material P, the heater 104 includes an elongated substrate 104a made of ceramic. On the film contact surface side of the substrate 104a, resistance heating elements 104b as heating layers that generate heat by power application is arranged in each of an end portion on an upstream side and an end portion on a downstream side in the conveyance direction of the recording material P along a longitudinal direction of the substrate 104a. The resistance heating elements 104b are covered with a surface protecting layer 104c such as glass having an insulation property. The surface protecting layer 104c is arranged on the film contact surface side of the substrate 104a.

A connection conductive portion 104dL for connecting the resistance heating elements 104b is arranged in a left end portion on the film contact surface side of the substrate 104a. Conductive portions 104dR independently connected to the resistance heating elements 104b are arranged in a right end portion on the film contact surface side of the substrate 104a. The connection conductive portion 104dL and the conductive portion 104dR respectively include electrode portions 104eL and 104eR.

As illustrated in FIG. 1, the heater 104, the holder (the supporting member) 103, and a metal stay 106 are inserted into a hollow portion of the film 101. In the longitudinal direction perpendicular to the conveyance direction of the recording material P, the heater 104 is supported by a recessed groove 103a (see FIG. 1) arranged in the holder 103 having heat resistance and slidability. The recessed groove 103a of the holder 103 includes a supporting surface 103a-1 for supporting the heater 104 from a side of the second surface of the heater 104. The holder 103 also functions as a guide for guiding rotation of the film 101.

The metal stay 106 is arranged on a flat surface of the holder 103 on a side opposite to the heater 104. The stay 106 is formed in a U-shape in cross section, and enhances flexural rigidity of the holder 103 in the longitudinal direction perpendicular to the conveyance direction of the recording material P. The stay 106 also functions as a positioning reference with respect to the holder 103.

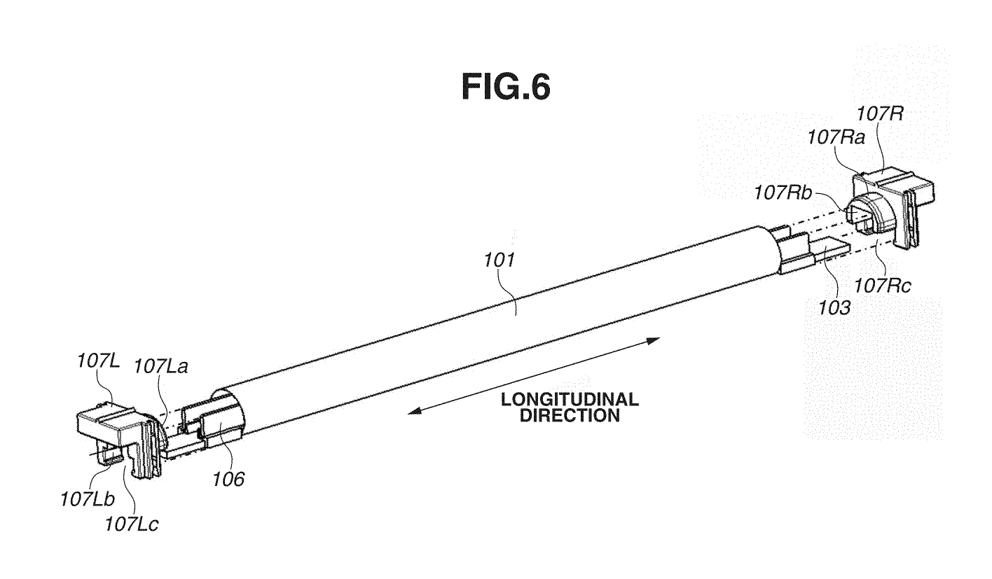

FIG. 6 is a perspective view illustrating a positional relation of the film 101, the holder 103, the stay 106, and flanges 107L and 107R.

As illustrated in FIG. 6, in the longitudinal direction perpendicular to the conveyance direction of the recording material P, both end portions of the film 101 are rotatably supported by respective outer peripheral surfaces of semicircular arc-shaped guide portions 107La and 107Ra of the flanges 107L and 107R. Both end portions of the stay 106 are respectively fit into recessed portions 107Lb and 107Rb arranged on inner sides of the guide portions 107La and 107Ra of the flanges 107L and 107R. Both end portions of the holder 103 are respectively fixed in a supported manner by engagement recessed portions 107Lc and 107Rc arranged below the guide portions 107La and 107Ra of the flanges 107L and 107R.

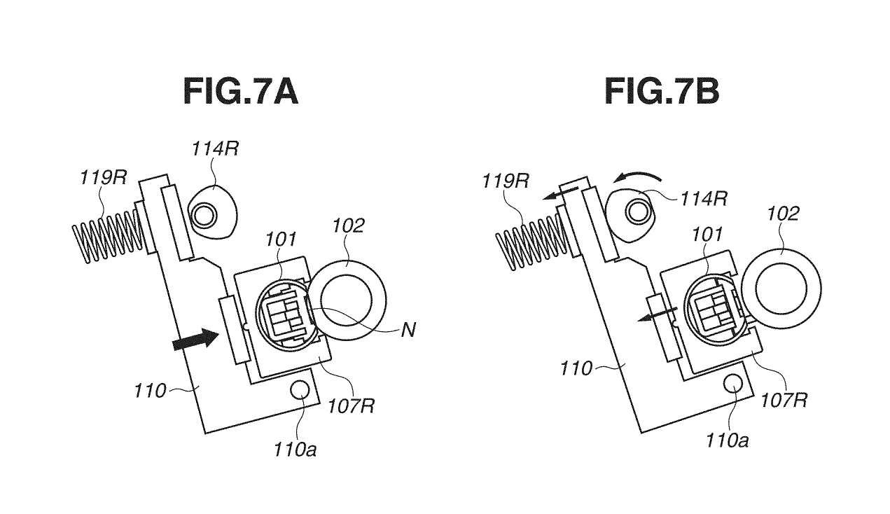

FIGS. 7A and 7B are schematic diagrams illustrating a configuration of a pressure mechanism of the flange 107R (and the flange 107L). FIG. 7A is a diagram illustrating a state in which the flange 107R (and the flange 107L) is pressurized. FIG. 7B is a diagram illustrating a state in which the flange 107R (and the flange 107L) is released from the pressurized state. In the longitudinal direction perpendicular to the conveyance direction of the recording material P, the pressure mechanisms are arranged symmetrically, so that only the right-side pressure mechanism is illustrated in each of FIGS. 7A and 7B.

As illustrated in FIG. 7A, a pressure spring 119R pressurizes the flange 107R via a pressing member 110 in a vertical direction (a direction indicated by an arrow) perpendicular to a generatrix direction of the film 101, so that the flange 107R presses down the holder 103 in the same direction. Accordingly, the holder 103 presses the heater 104 to an inner surface of the film 101 such that an outer peripheral surface (outer surface) of the film 101 is brought into contact with an outer peripheral surface (outer surface) of the pressing roller 102 under pressure. Thus, the elastic layer 102b of the pressing roller 102 is crushed and elastically deformed, and a nip portion N having a predetermined width is formed by the outer surface of the film 101 and the outer surface of the pressing roller 102.

During the print operation, the pressing member 110 is in a contact position in which the pressing member 110 contacts the flanges 107R. However, at the time of power off or paper jam, the pressing member 110 is in a separation position in which the pressing member 110 is separated from the flange 107R. Switching between the contact position and the separation position is made by rotation of the pressing member 110 by rotating a cam 114R as illustrated in FIG. 7B.

During the print operation performed by the image forming apparatus 1, the pressing member 110 of the fixing apparatus 100 is not in contact with the cam 114. At the time of power-off of the image forming apparatus 1 or at the time of paper jam in a recording material conveyance path, the cam 114 is rotated by 180 degrees by a motor (not illustrated). The rotation of the cam 114 lifts the pressing member 110 in a direction indicated by an arrow illustrated in FIG. 7B around a shaft 110a of the pressing member 110 against pressure of the pressing spring 119R. Herein, the flange 107R is also lifted in the same direction, thereby lifting the holder 103 in the same direction. The lift of the holder 103 separates the outer surface of the film 101 from the outer surface of the pressing roller 102.

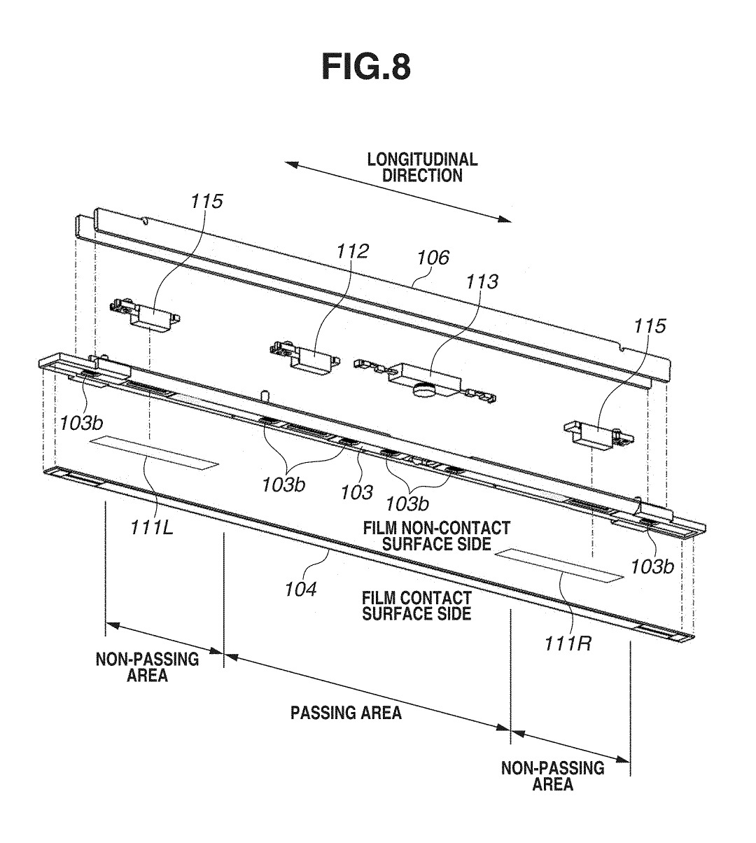

FIG. 8 is a perspective view illustrating a positional relation of the heater 104, the holder 103, the stay 106, a thermistor 112, sub-thermistors 115, and a thermostat 113.

As illustrated in FIG. 8, in the longitudinal direction perpendicular to the conveyance direction of the recording material P, the thermistor (a first temperature detection element) 112 contacts an area that is on a film non-contact surface side of the heater 104 and corresponds to a passing area of the nip portion N. Moreover, the thermostat (a power application interruption element) 113 such as a thermoswitch and a temperature fuse contacts the area which is on the film non-contact surface side of the heater 104 and corresponds to the passing area of the nip portion N. The thermostat 113 is operated to interrupt a power supply line to the heater 104 when the temperature of the heater 104 abnormally rises. On the other hand, the sub-thermistors (second temperature detection elements) 115 contact areas that are on the film non-contact surface side of the heater 104 and correspond to non-passing areas of the nip portion.

Herein, the term “passing area” represents an area through which a small size recording material and a large size recording material pass. The term “non-passing area” represents an area through which a large size recording material passes but a small size recording material does not pass. That is, in the longitudinal direction perpendicular to the conveyance direction of the recording material P, the non-passing areas are positioned on both sides of the passing area through which the small size recording material passes.

The heater 104 is attached to an attachment point 103b on the holder 103 using silicone adhesive (Shin-Etsu Silicone KE3417 manufactured by Shin-Etsu Chemical Co., Ltd). Such attachment prevents a phenomenon in which the heater 104 is lifted from the holder 103 by pressure of the thermistor 112, the sub-thermistors 115, and the thermostat 113 in a case where the surface of the film 101 is separated from the surface of the pressing roller 102.

### <Heat Fixing Process Operation>

A heat fixing process operation performed by the fixing apparatus 100 is described with reference to FIG. 1.

A driving force of the motor (not illustrated) is transmitted to the metal core 102a of the pressing roller 102, so that the pressing roller 102 is rotated in a direction indicated by an arrow illustrated in FIG. 1. The film 101 is rotated in a direction indicated by an arrow illustrated in FIG. 1 by following the rotation of the pressing roller 102 while an inner surface of the film 101 is in contact with the surface protecting layer 104c of the heater 104.

In a case where electric power is supplied to the resistance heating elements 104b of the heater 104 from an alternating-current power supply (not illustrated) via the electrode portions 104eL and 104eR, the connection conductive portion 104dL, and the conductive portions 104dR, the resistance heating elements 104b generate heat. This causes temperature of the heater 104 to rapidly rise. A temperature control unit (not illustrated) obtains a detection temperature detected by the thermistor 112 (see FIG. 8) arranged on the holder 103 to control an amount of power to be supplied to each of the resistance heating elements 104b such that the detection temperature is maintained at a predetermined fixing temperature (a target temperature). The sub-thermistor 115 is used to detect an excess temperature rise in the non-passing area.

The recording material P bearing an unfixed toner image T is heated while being pinched and conveyed by the nip portion N, thereby fixing the toner image T on the recording material P.

### <Description of Graphite Sheets 111L and 111R>

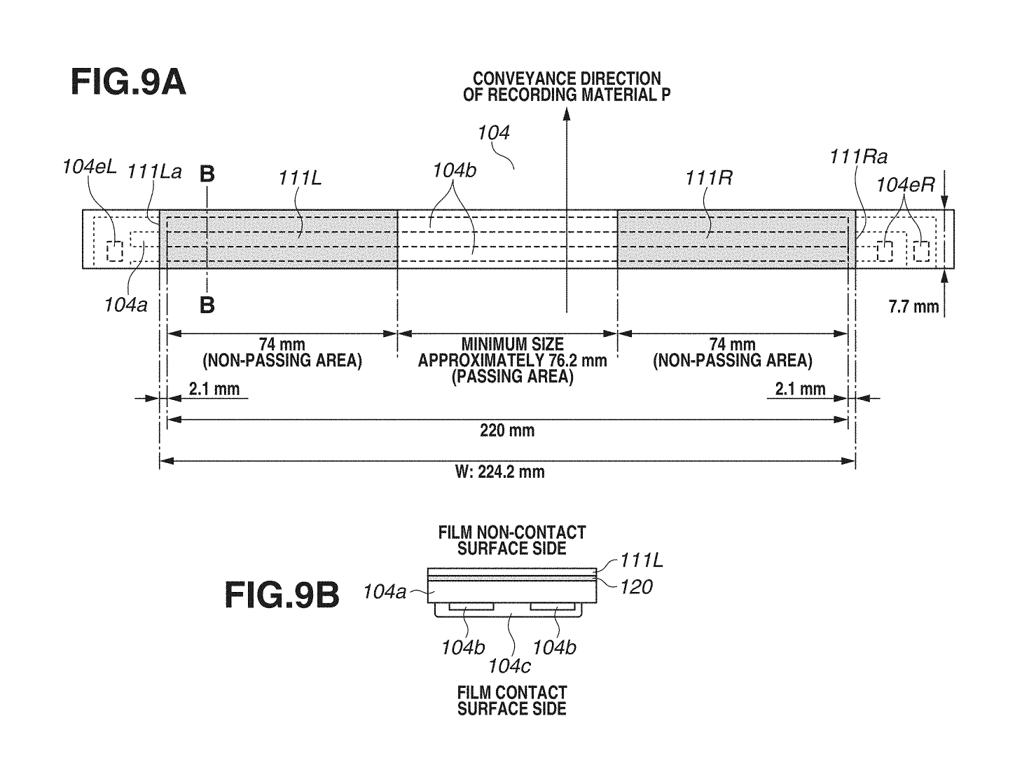

FIGS. 9A and 9B are diagrams illustrating a positional relation of the heater 104 and graphite sheets 111L and 111R. FIG. 9A is a diagram illustrating the heater 104 as seen from the film non-contact surface side. FIG. 9B is a sectional view of the heater 104 along the line B-B of FIG. 9A.

The graphite sheets 111L and 111R are arranged between the heater 104 and the holder 103 as illustrated in FIG. 8. Each of the graphite sheets 111L and 111R having flexibility has a thermal conductivity of 1000 W/mK in a surface direction, a thermal conductivity of 15 W/mK in a thickness direction, a thickness of 70 μm, and a density of 1.2 g/cm³. In the conveyance direction of the recording material P as illustrated in FIG. 9A, each of the graphite sheets 111L and 111R has a width of 7.7 mm that is substantially the same as a width of the heater 104.

In the longitudinal direction perpendicular to the conveyance direction of the recording material P, the graphite sheets 111L and 111R are separately arranged in the respective non-passing areas through which a recording material P having a minimum width conveyed by the nip portion N does not pass.

A minimum size recording material P on which print operation can be performed by the image forming apparatus 1 of the present exemplary embodiment has a width of 3 inches (=76.2 mm). In the passing area through which the minimum size recording material P passes, the heat of the heater 104 is taken by the recording material P. Consequently, an excessive temperature rise (a non-passing portion temperature rise) does not occur in the passing area. For the reason, the graphite sheets 111L and 111R are separately arranged on both respective sides (the non-passing areas) of the heater 104 excluding the 3-inch width of the minimum size, and each of the graphite sheets 111L and 111R has a length of 74 mm.

Moreover, in the longitudinal direction perpendicular to the conveyance direction of the recording material P, a length W from an outer end portion 111La of one graphite sheet 111L to an outer end portion 111Ra of the other graphite sheet 111R is greater than a length of each resistance heating element 104b of the heater 104. That is, a length of each resistance heating element 104b is 220 mm, whereas a distance W across the respective outer end portions of the separate graphite sheets 111L and 111R is 224.2 mm. Thus, the distance W is greater than the length of each resistance heating element 104b by 2.1 mm at each end portion. The both end portions of each resistance heating element 104b are respectively covered with the separate graphite sheets 111L and 111R, so that a non-passing portion temperature rise can be reliably suppressed even at the end portions of the resistance heating elements 104b.

The outer end portions 111La and 111Ra of the respective graphite sheets 111L and 111R overlap the resistance heating element 104b. A length of such overlap can be determined as necessary to suppress a non-passing portion temperature rise that varies depending on a printing speed of the image forming apparatus 1 or a configuration of the fixing apparatus 100.

Next, a description is given of a fixation method for the graphite sheets 111L and 111R in consideration of thermal expansion of the graphite sheets 111L and 111R, the heater 104, and the holder 103.

The graphite sheets 111L and 111R, the heater 104, and the holder 103 are made of different materials. Each of the members used in the present exemplary embodiment has a linear expansion coefficient as follows. The substrate 104a of the heater 104 is made of aluminum, and has a linear expansion coefficient within the range of 7×10⁻⁶ mm/° C. to 8×10⁻⁶ mm/° C. The holder 103 is made of liquid crystal polymer, and has a linear expansion coefficient of 1.3×10⁻⁵ mm/° C. Each of the graphite sheets 111L and 111R has a linear expansion coefficient within the range of 8×10⁻⁷ mm/° C. to 9.5×10⁻⁷ mm/° C.

In the fixing apparatus 100, the temperature of the heater 104 rises until a surface temperature of the film 101 reaches a fixing temperature, and the heater 104 cools down to room temperature by natural cooling upon completion of a fixing operation. Each of the heater 104 and the holder 103 thermally expands in the course of temperature rise, and shrinks in the course of cooling.

In a case where a non-passing portion temperature rise occurs in the heater 104 due to continuous print operation on small size recording materials, the temperature of the heater 104 can become 250° C. or more. In such a case, since temperature of the standard office environment is 26° C., a temperature difference between such a heater 104 and the standard office environment is 224° C. or more that is large. Such a temperature difference causes the heater 104 to thermally expand by 0.13 mm and the holder 103 to thermally expand by 0.20 mm per length of 74 mm of each of the graphite sheets 111L and 111R. On the other hand, each of the graphite sheets 111L and 111R thermally expands by only 0.01 mm. The inventors have found that that the use of an elastically deformable material having a small Young's modulus as a material for fixing the graphite sheets 111L and 111R to the heater 104 or the holder 103 can reduce a shear force to be applied to the graphite sheets 111L and 111R.

In the present exemplary embodiment, the graphite sheets 111L and 111R are fixed to the heater 104. An adhesive layer 120 including pressure-sensitive adhesive such as two-sided adhesive tape or adhesive is used as a unit for fixing the graphite sheets 111L and 111R to the heater 104. The adhesive mentioned here is initially liquid and is designed so as to be solid by drying, cooling, or chemical reaction after marrying the adhesive with the adherend. On the other hand, the pressure-sensitive adhesive mentioned here is an adhesive which forms a bond by the application of light pressure to marry the adhesive with the adherend.

### <Effect Verification-1>

A verification of an effect of the fixing apparatus 100 according to the present exemplary embodiment is described.

An effect of suppressing a non-passing portion temperature rise was checked as effect verification by a durability test. The durability test was executed under the following conditions. An apparatus capable of continuously performing a print operation on A4 size recording materials P at 35-sheet per minute was used as an image forming apparatus. Moreover, A5 size paper (PB PAPER having a grammage of 64 g/m2, manufactured by Canon Inc.) causing a non-passing portion temperature rise to be larger was used as a recording material P. In addition, an image forming condition was set. According to the image forming condition, the image forming apparatus was stopped for 18 minutes after 50 recording materials P continuously passed through a nip portion, and such an operation was repeated as one cycle. Printing was performed on only one side of the recording material P under the environment of 26° C./65% (temperature/humidity) on the assumption that the printing was performed in normal office environment. The durability test was executed up to the durable number of sheets of 225,000 that was the durability life of the image forming apparatus.

The effect of suppressing the non-passing portion temperature rise was checked. Particularly, the non-passing portion temperature rise in a case where the continuous printing was performed on 50 sheets of A5 size (PB PAPER having a grammage of 64 g/m², manufactured by Canon Inc.) as a small size recording material was checked using a detection temperature of the sub-thermistor 115.

An adhesive layer 120 verified as an example 1 of the present exemplary embodiment was two-sided adhesive tape (an adhesive member) of silicone-based pressure-sensitive adhesive (TRAN-SIL NT-1001 having a sticky adhesive layer thickness of 50 μm, manufactured by Taiyo Wire Cloth Co., Ltd.). The two-sided adhesive tape of the example 1 included only a pressure-sensitive adhesive layer, and did not include a base material. An adhesive layer 120 verified as an example 2 was silicone adhesive (Shin-Etsu Silicone KE3417 manufactured by Shin-Etsu Chemical Co., Ltd) described above. Verification results of the examples 1 and 2 are illustrated in Table 1.

An adhesive layer 120 verified as a comparative example was two-sided adhesive tape of general acrylic pressure-sensitive adhesive (467 MP having a pressure-sensitive adhesive layer thickness of 50 μm, manufactured by 3M Japan Limited) that was selected as pressure-sensitive adhesive.

Table 1 illustrates detection temperatures of the sub-thermistor 115 in a case where 50 recording materials of A5 size continuously passed through the nip portion, and the states of the graphite sheets 111L and 111R presumed based on the detection temperatures. A non-passing portion temperature rise in a case where the graphite sheets 111L and 111R were not arranged was approximately 250° C. or more. However, in a case where the graphite sheets 111L and 111R were arranged to suppress a non-passing portion temperature rise, the temperature of the non-passing portion was approximately 228° C. or less. Thus, the arrangement of the sheets 111L and 111R was able to reduce the temperature by approximately 22° C.

TABLE 1

| | | COMPARATIVE | | |
|---|---|---|---|---|
| | | EXAMPLE | EXAMPLE 1 | EXAMPLE 2 |
| ADHESIVE | | ACRYLIC PRESSURE- | SILICONE-BASED | SILICONE- |
| LAYER | | SENSITIVE | PRESSURE- | BASED |
| | | ADHESIVE | SENSITIVE | ADHESIVE |
| | | (TWO-SIDED | ADHESIVE | |
| | | ADHESIVE TAPE) | (TWO-SIDED | |
| | | | ADHESIVE TAPE) | |
| YOUNG'S | | 2 to 5 GPa | 15 MPa OR LESS | 15 MPa OR |
| MODULUS | | | | LESS |
| DURABILITY | INITIAL | 228° C. OR | 228° C. OR | 228° C. OR |
| NUMBER OF | | LESS/GOOD | LESS/GOOD | LESS/GOOD |
| SHEETS | 5,000 | 228° C. OR | 228° C. OR | 228° C. OR |
| | SHEETS | LESS/GOOD | LESS/GOOD | LESS/GOOD |
| | 10,000 | 228° C. OR | 228° C. OR | 228° C. OR |
| | SHEETS | LESS/GOOD | LESS/GOOD | LESS/GOOD |
| | 20,000 | 231° C. OR | 228° C. OR | 228° C. OR |
| | SHEETS | LESS/LAYER | LESS/GOOD | LESS/GOOD |
| | | DISPLACEMENT OF | | |
| | | GRAPHITE SHEETS | | |
| | 50,000 | 236° C. OR | 228° C. OR | 228° C. OR |
| | SHEETS | LESS/LAYER | LESS/GOOD | LESS/GOOD |
| | | DISPLACEMENT OF | | |
| | | GRAPHITE SHEETS | | |
| | 100,000 | 245° C. OR MORE/ | 228° C. OR | 228° C. OR |
| | SHEETS | →FRACTURE OF | LESS/GOOD | LESS/GOOD |
| | | GRAPHITE SHEET | | |
| | | AND END | | |
| | 150,000 | NA | 228° C. OR | 228° C. OR |
| | SHEETS | | LESS/GOOD | LESS/GOOD |
| | 225,000 | NA | 228° C. OR | 228° C. OR |
| | SHEETS | | LESS/GOOD | LESS/GOOD |

In the comparative example, the two-sided adhesive tape of acrylic pressure-sensitive adhesive was checked. In this case, since Young's modulus was 2 to 5 GPa that was large, a shearing force generated by thermal expansion of the heater 104 was applied to the graphite sheets 111L and 111R without reduction of the shearing force. Then, a load was repeatedly added, so that the graphite sheets 111L and 111R were displaced between layers. Eventually, the graphite sheets 111L and 111R fractured.

As the examples 1 and 2, the two-sided adhesive tape made of silicone-based pressure-sensitive adhesive and the silicone-based adhesive were used as respective adhesive layers 120 in the verification. Each of the two-sided adhesive tape made of silicone-based pressure-sensitive adhesive and the silicone-based adhesive had a small Young's modulus of 15 MPa, and thus was elastically deformable.

In the examples 1 and 2, it was conceivable that the shearing force generated by thermal expansion of the heater 104 due to the non-passing portion temperature rise was absorbed by elastic deformation of the adhesive layer 120 made of silicone-based adhesive. Accordingly, a configuration in which the shearing force causing a fracture of the graphite sheets 111L and 111R was not added was able to be provided.

Moreover, the silicone-based adhesive had a high heat resistant temperature of 250° C. Even in a case where the temperature of the heater 104 became 228° C. due to the non-passing portion temperature rise, it was confirmed that stickiness of the silicone-based adhesive as the adhesive layer 120 remained.

With these effects, it was confirmed that a non-passing portion temperature rise could be stably suppressed throughout the durability life of the fixing apparatus 100 without a fracture of the graphite sheets 111L and 111R even if the image forming apparatus 1 exceeded the durability life thereof.

### <Effect Verification-2>

The effect verification-1 of the exemplary embodiment has been described using verification of two-sided adhesive tape without a base material. In the effect verification-2, a verification result of an example 3 in which two-sided adhesive tape with a base material is used is described.

As described above, each of the graphite sheets 111L and 111R is brittle because of the graphite layer structure. Moreover, since each of the graphite sheets 111L and 111R is thin with a thickness of 75 μm, mechanical strength is low. Hence, the graphite sheets 111L and 111R may tear when handled.

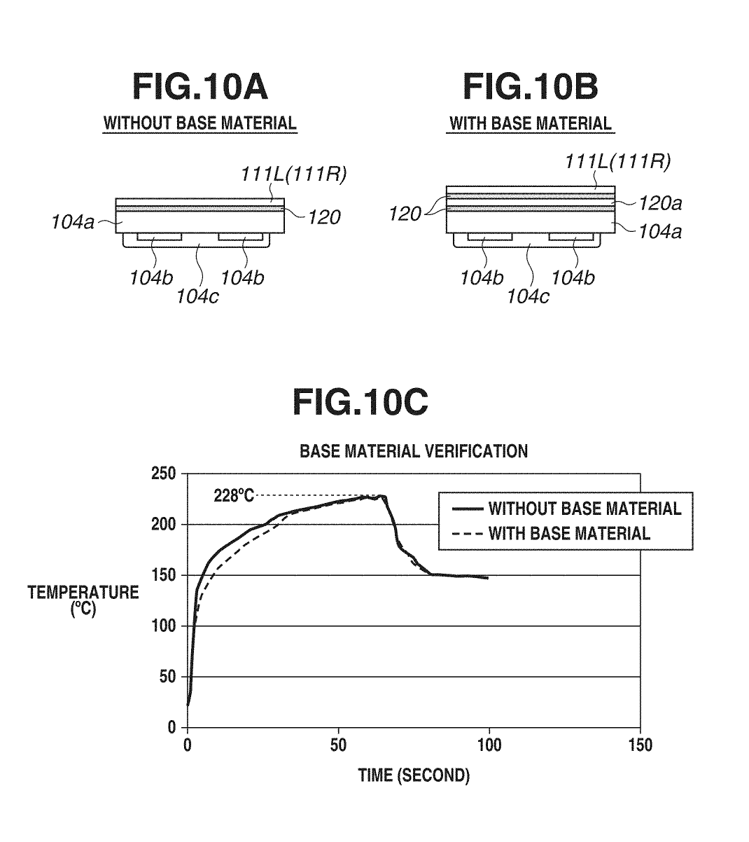

Accordingly, a description is given of an application example of a configuration in which two-sided adhesive tape with a base material 120a is used for the adhesive layer 120 to not only enhance mechanical strength but also facilitate handling, with reference to FIG. 10.

Similar to the example 1, influences on a non-passing portion temperature rise depending on the presence of absence of the base material 120a in the two-sided adhesive tape using silicone-based pressure-sensitive adhesive were compared.

The following comparison condition was used. Detection temperatures of the sub-thermistor 115 in a case where 50 sheets of A5 size (PB PAPER having a grammage of g/m², manufactured by Canon Inc.) continuously passed through a nip portion in the image forming apparatus used in the effect verification-1 were compared. Printing was performed on only one side of the recording material P, and execution environment was substantially the same as the environment condition described above. The base material 120a of the two-sided adhesive tape had a thickness of 30 μm and was made of polyimide (PI).

FIG. 10A is a sectional view illustrating a case where a graphite sheet 111L (111R) is fixed to the heater 104 by using an adhesive layer 120 without a base member (the example 1). FIG. 10B is a sectional view illustrating a case where a graphite sheet 111L (111R) is fixed to the heater 104 by using adhesive layers 120 with a base member (the example 3). The adhesive layers 120 of the example 3 are pressure-sensitive adhesive layers formed of silicone-based pressure-sensitive adhesive on one surface of the base member 120a and the other surface of the base member 120a. FIG. 10C is a diagram illustrating a result of detection temperatures of the sub-thermistor 115 of the heater 104 illustrated in FIGS. 10A and 10B.

As illustrated in FIG. 10C, in a case where the two-sided adhesive tape (an adhesive member) with the base material 120a was used as the adhesive layer 120, a temperature rise of the heater 104 was detected by the sub-thermistor 115 with a delay. Such a delay occurred since the temperature rise of the heater 104 was transmitted from the heater 104 to the silicone adhesive layer 120, to the base material 120a, to the silicone adhesive layer 120, and to the sub-thermistor 115 in this order, so that the thermal resistance became large in the case with the base material 120a compared to the case without the base material 120a.

Meanwhile, the sub-thermistor 115 is to control, for example, productivity with respect to an upper limit temperature of the non-passing portion temperature rise. The thermistor 115 can employ the configuration of the example 3 in the specification of an image forming apparatus capable of accepting responsiveness in a transient state.

As described above, using the graphite sheets 111L and 111R fixed to the heater 104 by the adhesive layers 120, the fixing apparatus 100 of the present exemplary embodiment can not only facilitate handling of the graphite sheets 111L and 111R but also suppress a non-passing portion temperature rise.

The examples 1 through 3 of the present exemplary embodiment have been described using silicone-based adhesive or two-sided adhesive tape using silicone-based pressure-sensitive adhesive as the adhesive layer 120. However, the present exemplary embodiment is not limited thereto as long as heat resistant temperature or Young's modulus of the silicone-based pressure-sensitive adhesive or silicone-based adhesive used for the adhesive layer 120 can provide the fixing apparatus 100 as intended.

Moreover, the present exemplary embodiment has been described using a configuration in which the graphite sheets 111L and 111R are fixed to the heater 104. However, the fixation of the graphite sheets 111L and 111R is not limited to the heater 104. Even if the graphite sheets 111L and 111R are fixed to the holder 103, similar effects can be provided.

In the present exemplary embodiment, the separate graphite sheets 111L and 111R are arranged on respective end portions of the heater 104, and each of the end portions of the heater 104 corresponds to a non-passing area of a nip portion N. Such arrangement is made to reduce a non-passing portion temperature rise. A graphite sheet may be arranged across a longitudinal direction including a middle portion of the heater 104. The middle portion corresponds to a passing area of the nip portion N. Even in such a case, effects of the fixing apparatus 100 are not changed.

Therefore, in the present exemplary embodiment, a graphite sheet as a heat conductive member is fixed to the heater 104 or the holder 103 by using an adhesive layer 120 made of an elastically deformable silicone material having a small Young's modulus to suppress a non-passing portion temperature rise of the heater 104. This enables the non-passing portion temperature rise of the heater 104 to be suppressed without a fracture of the graphite sheet throughout the durability life of the fixing apparatus 100.

Moreover, as for the suppression of the non-passing portion temperature rise of the heater 104, electric power to be supplied to the heater 104 is controlled based on a detection temperature of the sub-thermistor 115 arranged on each side of the heater 104 in which the non-passing portion temperature rise occurs. Alternatively, a non-passing portion temperature rise is suppressed by decreasing productivity by extending intervals between the current recording material and the preceding/following recording material at the time of continuous printing. An image forming apparatus in which the fixing apparatus 100 of the present exemplary embodiment is installed can minimize reduction in productivity by suppressing a non-passing portion temperature rise of the heater 104 by using a graphite sheet fixed to the heater 104 or the holder 103 of the fixing apparatus 100.

Usage of the image heating apparatus according to the present disclosure is not limited to a fixing apparatus as described in the exemplary embodiment. The image heating apparatus can be effectively used as an image reforming apparatus for reforming glossiness of an image (a fixed image) once fixed on a recording material or a temporarily fixed image (a semi-fixed image) on a recording material.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2016-250829, filed Dec. 26, 2016, which is hereby incorporated by reference herein in its entirety.

What is claimed is:

1. A fixing apparatus comprising:
a tubular film;
a heater including a first surface and a second surface opposite to the first surface, the first surface being to contact an inner surface of the film;
a supporting member including a supporting surface for supporting the heater from a side of the second surface; and
a heat conductive member arranged between the second surface of the heater and the supporting surface of the supporting member,
wherein a toner image is fixed on a recording material with heat of the heater via the film, and
wherein the heat conductive member is attached to at least one of the second surface of the heater and the supporting surface of the supporting member via an adhesive member including silicone-based pressure-sensitive adhesive or silicone-based adhesive.

2. The fixing apparatus according to claim 1, wherein the heat conductive member is a graphite sheet.

3. The fixing apparatus according to claim 1, further comprising a roller that forms a nip portion with the heater via the film,
wherein the recording material with the toner image formed thereon is heated in the nip portion while being conveyed.

4. The fixing apparatus according to claim 1, wherein the second surface of the heater and the heat conductive member are attached using only the silicone-based pressure-sensitive adhesive.

5. The fixing apparatus according to claim 1, wherein the adhesive member includes a base material and pressure-sensitive adhesive layers formed of the silicone-based pressure-sensitive adhesive, the pressure-sensitive adhesive layers being arranged on one surface of the base member and another surface of the base member.
